(19) United States
(12) Patent Application Publication
(10) Pub. No.: US 2023/0244483 A1
(43) Pub. Date: Aug. 3, 2023

(54) BASIC TECHNICAL PRINCIPLE AND IMPLEMENTATION OF DECIMAL COMPUTER

(71) Applicant: Shaowei MIN, Shenzhen (CN)

(72) Inventor: Shaowei MIN, Shenzhen (CN)

(21) Appl. No.: 18/297,695

(22) Filed: Apr. 10, 2023

Related U.S. Application Data
(63) Continuation of application No. PCT/CN2020/121715, filed on Oct. 17, 2020.

(30) Foreign Application Priority Data
Oct. 10, 2020 (CN) 202011074626.9

(51) Int. Cl. G06F 9/30

(52) U.S. Cl. CPC G06F 9/30025; G06F 9/3001; G06F 9/30105

(57) ABSTRACT

Principle and implementation of a new decimal electronic computer are provided in this disclosure, which belongs to field of electronic computers. A traditional computer was invented by Americans in 1946, which is binary, and data in the computer has only two states of 0 and 1. The binary states 0 and 1 are combined to represent various symbols and numbers, and various registers for binary algorithm are used to complete computation. Core of this disclosure is to use unit decimal data, a 10-bit hardware computation register group directly uses decimal numbers for computation, and one number has 10 states, so that operation and output of the decimal data can be directly completed. In the decimal computer, a CPU is composed of decimal computing register hardware at the bottom, which together with an auxiliary crossbar control circuit, a decimal memory and a decimal operating system, forms a complete decimal computer system.

### CROSS-REFERENCE TO RELATED APPLICATIONS

This application is a continuation of International Patent Application No. PCT/CN2020/121715 with a filing date of Oct. 17, 2020, designating the United States, now pending, and further claims priority to Chinese Patent Application No. 202011074626.9 with a filing date of Oct. 10, 20201. The content of the aforementioned applications, including any intervening amendments thereto, are incorporated herein by reference.

### TECHNICAL FIELD

The present disclosure belongs to the field of decimal electronic computers under general concept of electronic computer (including decimal computer software, a hardware system architecture, a crossbar controller group between register groups specially needed by the decimal computer, a decimal computer instruction system, a decimal computation register and various auxiliary systems in the decimal computer architecture, an operating system of the decimal electronic computer and a storage system of the decimal electronic computer).

### BACKGROUND ART

Since Americans firstly invented modern electronic computers (including embedded microcomputers, various personal computers and various huge super computers) in 1946, from original 4-bit electronic computers, 8-bit electronic computers, 16-bit electronic computers, 32-bit electronic computers to current 64-bit electronic computers, binary codding and computation are adopted in all of the electronic computers in the market, and almost all of binary computers are computers with a Von Neumann architecture. There are only two numbers 0 and 1 in a binary system, and all of other numbers, characters, control symbols, various instructions, data storage, and other technical schemes and implementations that any of other computers needs to use are realized with various complicated arrangements and combinations of 0 and 1.

### Problems to be Solved

1. At present, computers we generally talk about are all traditional binary computers that originated in 1946. Largest inconvenience of the binary computer is that data is too simple and each data bit has only one BIT which has only two states: 0 and 1. Therefore, if complex content is desired to be expressed, very complicated logical combination has to be made so as to express its uniqueness.

2. At present, computation is generally made in a decimal manner, and carry relationships in a decimal system (unit place, ten place, hundred place, thousand place, ten thousand place, etc.) are particularly easy to understand and learn. However, it is particularly troublesome to understand binary numbers, and binary data needs to be converted into a decimal form so as to be understood, so generally ordinary non-professionals don't interact with binary numbers, and most people can't read them.

3. A binary system has an advantage of being conveniently expressed on a machine, and both binary digits 0 and 1 can be correctly expressed by using a high and low level of a data BIT. Therefore, before the disclosure, no good way is found, and there was no reasonable register model that could express unit decimal data, that is to say, there was no good way to directly express unit data by using registers.

4. Due to reasons 1 to 3 listed above, although the decimal system has a very special advantage compared with the binary system, a decimal computer has not been developed, and even no one has developed the decimal computer at all.

### Solution

The following is description of core technical principle and schemes of this disclosure.

1. New expression of 10 states of unit data in decimal computer technology is developed in this disclosure. A register of this disclosure, like a binary register, can be configured to express states of 10 numbers very accurately.

2. More than 10 numbers are expressed through a single-bit decimal register in this disclosure. Then the single-bit decimal register can be combined into a multi-bit register group and to be a smallest core unit of the decimal computer of this disclosure.

3. Register group: various types of registers such as addition registers, subtraction registers, multiplication registers and division registers and register groups required by the decimal computer can be combined into a multi-bit register through above two basic register implementations, and finally all types of register groups required can be realized.

4. A computer composed of decimal registers outputs states of 10 BITs, so various modules are needed between different functional register groups and different functional modules to control transmission and exchange of data, which are called crossbars. Because the decimal computer has technical characteristics in aspects 1 to 4, a whole core computing structure model and an auxiliary crossbar controller model are completely different from various previous binary control modules, and there will be many new things designed according to needs that were completely absent before.

5. Because there are 10 BITs for data bit, only one of them is needed when used as a number. However, there are more than 1000 combinations of 10 BITs, and with various combinations except the one for the number, other 2 to 9 BITs can be combined to realize unit data for expressing complex codes such as characters, operators, control symbols and UNICODE codes (using 2 data bits). These operators, control symbols and Unicode codes constitute an instruction set system that can be expressed by one bit of data.

6. By controlling operations of a hardware register group with the above instruction set system, all types of necessary computation can be completed, and combined with a data storage system, an input and output (IO) system, an external interface, a power supply and other necessary subsystems of the computer required by decimal data, a whole system of the decimal computer according to this disclosure can be obtained.

### Beneficial Effects

Description of the beneficial effects of the disclosure is listed below.

1. The decimal system is much easier to be understood and learnt than the binary system, and there is no need to learn those complicated things for binary system. The binary system is basically difficult to be understood completely, but the decimal system can be sufficiently understood through addition, subtraction, multiplication and division.

2. The decimal computer has high computation accuracy. Some of (actually most of) decimal fractions can't be accurately expressed as binary fractions, for example, in PYTHON, 0.1+0.2=0.30000000000000004, and a result is not equal to 0.3 as generally understood. There is always a problem of conversion accuracy in computation of a decimal number in a binary manner, but conversion is not required for the decimal system and thus absolute computation accuracy can be ensured in computing.

3. At present, the binary computer is 64-bit (binary number) at most (it takes decades from 4-bit to 8-bit, to 16-bit, and then to 32-bit, and finally to 64-bits). If 128-bit or 256-bit binary computer is developed, complexity of design work is unimaginable. 64 bits in the binary computer can be converted to only 20 bits in the decimal computer, and the decimal computer can be easily designed to be 100-bit, 1000-bit, or more according to actual needs, and it is very convenient to complete design and computation, just using physical superposition.

4. The binary computer computation is configured to compute based on simple registers cyclically switching according to machine instruction and to compute serially. The decimal computer can directly perform multi-bit parallel computation, with a computation speed and efficiency reaching thousands to tens of thousands times that of the binary computer.

5. Ultra-low power consumption. The decimal computation is simple, and power supply of computer registers can be controlled by bit, and the power consumption is only a few tenths of that of ordinary computers, while power consumption of large computers is only a few thousand to a few tens of thousands with same computing power.

6. Inputting and outputting via an I/O port of the computer. In the past, the binary computer needs to be configured with a register and to perform inputting or outputting in multiple steps. The decimal computer according to this disclosure only needs to be configured with a register and to perform inputting or outputting in one step.

7. High computational efficiency. The decimal computer can realize parallel computation of N-bit data, and machine language without complex transformation can be directly executed.

8. Computer data bit of the decimal computer has 10 BITs, which can express more than 1000 states, and in this way, numbers, characters, UNICODE, operators and functions are all can be expressed. Complex binary combination is not required for the data, and all computations are controlled by one data bit, which maximizes data efficiency and subsequent computation efficiency.

9. The decimal computer is with simple and efficient programming. The machine language is a high-level language (the machine language can be configured to directly operate underlying basic hardware registers to compute), and the high-level language can be directly programmed to be an executable code, and one line of code can serve to complete computation that the binary computer needs tens to hundreds of lines of code to complete, and a primary school student can undertake professional programming work of college graduates after learning addition, subtraction, multiplication and division.

10. An existing computer operating system structure model is changed, address lines with a width of more than 40 bits is introduced, and decimal data lines with a width of more than 100 bits is introduced, and the decimal computer has a TB-level direct addressing space. All large-scale applications with several GB that need external storage can directly resides in memory RAM. It takes at least a few minutes to start and execute large-scale applications using the binary computer, and it takes less than 0.001 second using a decimal computer and they can be clicked and opened.

11. The decimal computer changes a database operation mode, and database with several GB to several tens of GB can resides in the memory, and a response speed of querying data and providing data services can be improved by tens of thousands of times compared with the binary computer.

12. Calling between different software in the decimal computer is as fast and efficient as operating software. For example, XX can be forwarded to WeChat Moments without any pause or delay. A case where an Android machine may slow down after a period of use will never exist in the future.

13. At present, the most advanced Sunway computer in China may only need a small case of a personal computer in a new system according to this disclosure, and a computer with cost of several billion yuan will only takes less than 10 thousand yuan in the system according to this disclosure.

14. At present, a manufacturing process of high-end chips has reached a dead end of 3 to 5 nm with extremely high cost, and one tape-out takes tens of millions of dollars to hundreds of millions of dollars. The decimal computer has high computation efficiency and low power consumption, so there is no need to use the complex manufacturing process of 3 to 5 nm, and only needs very common production technology and extremely low production and manufacturing cost to reach a level of a current highest-performance computer.

### BRIEF DESCRIPTION OF THE DRAWINGS

FIG. 1 is a decimal basic register model of a decimal computer.

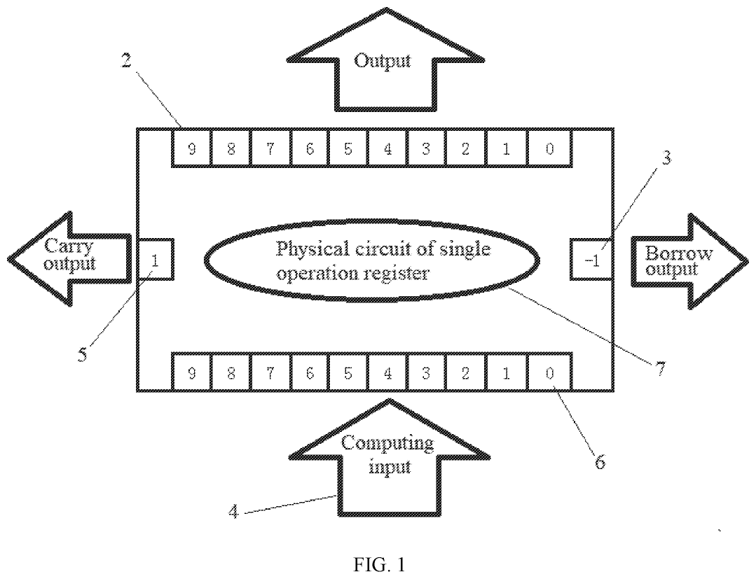

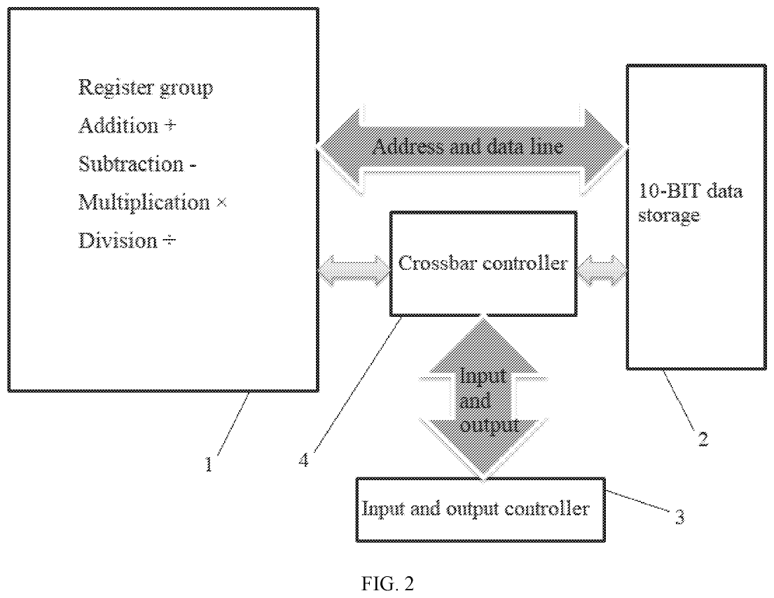

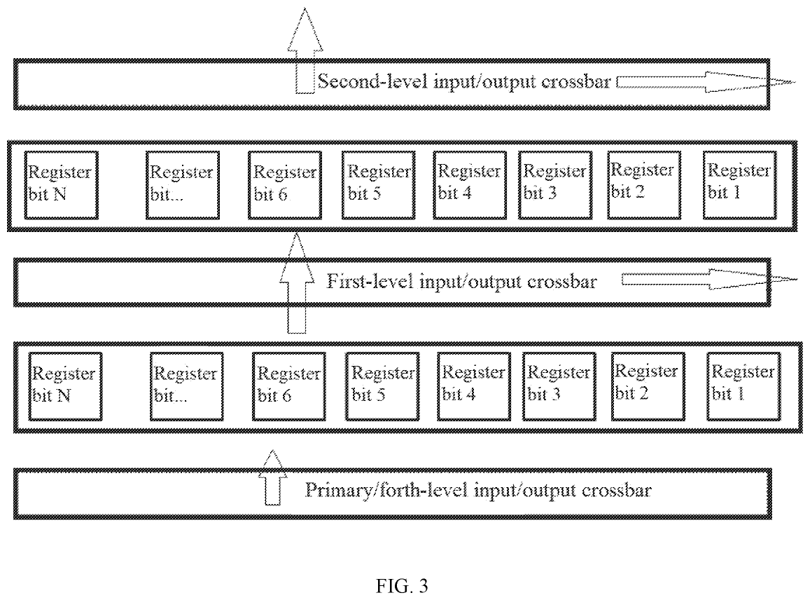

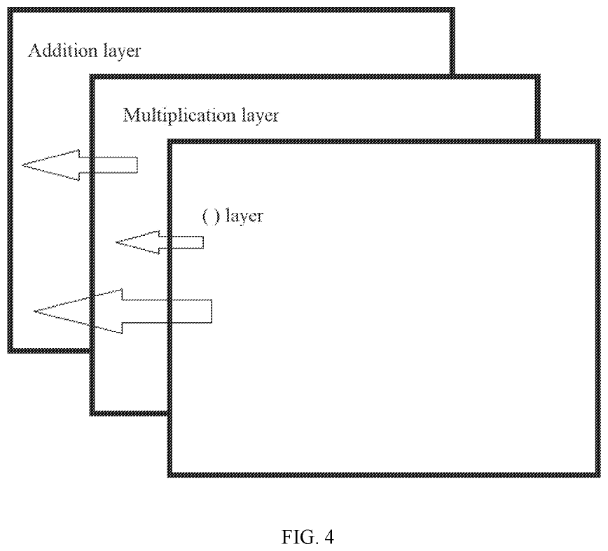

In this figure, reference number 1 represents an output port of a single-bit decimal register. Reference number 2 represents 10 BITs representing an output end of a single-bit decimal register. Reference number 3 represents an output end of a register in a carry state. Reference number 4 represents an input end of a decimal register for computation data. Reference number 5 represents an output end of a decimal register in a carry state. Reference number 6 represents 10 BITs representing a carry output end of a decimal register. Reference number 7 represents an internal core logic circuit representing a decimal register.

FIG. 2 is a basic principle architecture diagram of a decimal computer.

In the figure, reference number 1 represents an operation register group. Reference number 2 represents a memory where 10 BITs enter and exit data storage. Reference number 3 represents an input and output interface of a decimal computer; and reference number 4 represents various crossbar controllers of a decimal computer.

FIG. 3 is a multi-layer computation principle architecture diagram of a decimal computer register.

FIG. 4 is a model for data interleaving computation between different computation layers in different register groups of a decimal computer.

### DETAILED DESCRIPTION

### Best Mode

1. A core component CPU of a decimal computer is designed using a basic register, a register group and a support controller according to the disclosure.

2. The CPU of this design is connected directly with various peripheral devices of an existing binary computer to directly drive various ready-made peripheral devices so as to complete application of a new decimal computer.

3. Because the computing core used in the present disclosure contains various decimal register groups, machine code of an internal instruction set is required to be converted into a corresponding decimal register, and if an operating system of other existing computers need to be used on this decimal computer hardware system, underlying machine instructions and some computing code logic need to be adjusted accordingly. However, all types of computer codes designed in high-level language need to use hardware instructions that interface with the decimal computer in bottom-level compilation.

4. Because unit data of this computer is 10-BIT, stored 8-BIT codes and numbers used by traditional computers can be directly compatible and used after adjustment in this system. However, the 10-BIT data stored in this system as the decimal computer can't be stored or recognized and opened in a traditional binary computer, so the decimal computer can be compatible in data with data application of the traditional binary computer.

### Embodiments of the Present Disclosure

Specific registers, data expressions, operators, control symbols and other related descriptions of this scheme are described in the following.

(I) Hardware implementation of decimal computer, an overall structural model is shown in the above description and FIG. 2.

1. A decimal addition register, subtraction register and other required hardware register groups are designed in hardware circuit.

2. A crossbar controller is designed in hardware circuit, all types of registers for computation are connected through the crossbar controller.

3. A address line is more than 40-bit wide (combined according to actual needs) and a data line is more than 100-bit wide (combined according to actual needs), and an addressing space for direct hardware addressing is established, which can be used as an internal FLASH address, a RAM address, and used for other fast hardware addressing.

4. An external input and output system of the computer (an IO input and output, a keyboard, a display, etc.) is established by connecting external common IO ports, UART serial ports, USB ports, I2C interfaces, SPI interfaces, HDMI interfaces, SATA interfaces and other external interfaces via crossbars and latches.

5. External hard disks and other special memories using decimal data are externally connected through SATA and USB ports.

6. A hardware structure system described above can be started as a complete decimal computer system through a special BIOS boot program.

(II) Operating system of decimal computer. Operating system implementations from an embedded micro-system to a large supercomputer are classified according to needs of application scenarios, and are used matching products loaded with different hardware modules, and bit lengths and numbers of the related registers loaded in the CPU of a hardware part are different. The following is only for explanation of specially improved design over the binary computer, and other things not specified can be referred to mature technology of existing binary computers.

### Large-Scale Operating System for Large-Scale Research and Scientific Computation.

a) A data width of 80 to 100 bits is adopted, each with 10 BITs.

b) It can be expressed from (D1,0-D1,9); (D2,0-D2,9); . . . and (D100,0-D100,9).

c) 40 bits are reserved for an address line; 30 bits indicates 1G, and the width of 80 bits indicates a total width of 80 G, with a maximum hardware addressing space of 1024×80 G.

d) A dedicated chip can be directly placed in this addressable address as a database cache in RAM. If the dedicated chip is designed as the database cache, a DMA channel can be established between the chip and an external storage device for storage management.

e) BIOS address. 1 M starting from 0 is used as internal BIOS and internal ROM (FLASH) addresses, and a large system is with the data width of 80/100 bits, which indicates a total storage space of 80 M/100 M.

f) The system can be adapted to multi-user application needs.

### Medium-Sized Operating System for Company Server-Level Application.

a) A data width of 60 bits is adopted, each with 10 BITs.

b) It can be expressed from (D1,0-D1,9); (D2,0-D2,9); . . . and (D60,0-D60,9).

c) 40 bits are reserved for an address line; 30 bits indicates 1G, and the width of 60 bits indicates a total width of 60 G, with a maximum hardware addressing space of 1024×60 G.

d) A dedicated chip can be directly placed in this addressable address as a database cache in RAM. If the dedicated chip is designed as the database cache, a DMA channel can be established between the chip and an external storage device for storage management.

e) BIOS address. 1 M starting from 0 is used as internal BIOS and internal ROM (FLASH) addresses, and a large system is with the data width of 60 bits, which indicates a total storage space of 60 M.

f) The system can be adapted to multi-user application needs.

### Small Operating System Generally for Personal Computer and Mobile Phone.

a) A data width of 40 bits is adopted, each with 10 BITs.

b) It can be expressed from (D1,0-D1,9); (D2,0-D2,9); . . . and (D40,0-D40,9).

c) 40 bits are reserved for an address line; 30 bits indicates 1G, and the width of 40 bits indicates a total width of 60 G, with a maximum hardware addressing space of 1024×40 G, space can be allocated from this addressing space as a database in RAM.

d) BIOS address. 1 M starting from 0 is used as internal BIOS and internal ROM (FLASH) addresses, and a small system is with the data width of 40 bits, which indicates a total storage space of 40 M.

### Micro Operating System for Micro Embedded Products.

a) A data width of 20 bits is adopted, each with 10 BITs, and a data line is with 200 BITs.

b) It can be expressed from (D1,0-D1,9); (D2,0-D2,9); . . . and (D20,0-D20,9).

c) 40 bits are reserved for an address line; 30 bits indicates 1G, and the width of 20 bits indicates a total width of 20 G, with a maximum hardware addressing space of 1024×20 G.

d) 1 M starting from 0 is used as internal BIOS and internal ROM (FLASH) addresses, and a micro system is with the data width of 20 bits, which indicates a total storage space of 20 M, and startup information and programs can be stored in this space.

5. Core principles and architectures of the above systems are all the same, and instructions used are all the same (for part of large-scale computation registers, which is not used for the small system), and files and file formats used are all the same. There is no direct difference between systems, but different modules are loaded according to different needs and requirements of different hardware modules. Some of the modules does need to be loaded for some of the system, and some of the systems are only loaded with modules with different functions. As for debugging and display output parts, there can be a display, or printed results executed by the program are only output through a serial port, or the printed results are output to an image display desktop as required or not output to the display desktop.

Basic Bootloader BIOS, which is solidified using a mask or burned using a basic serial port.

7. Call of software modules. Same various functional modules are provided and the application module market is opened, and developers can choose to call according to their needs, thus greatly simplifying application development.

8. Peripheral devices and interfaces of this computer do not need to be improved. This computer can be directly interfaced with existing mature products, and interfaces requiring improvement are designed in a compatible way, and newly developed products are gradually upgraded to latest ones.

9. External Hardware Interfaces Supported by Default.

A. RAM, Different systems support different bit widths of addresses and different data linewidths, and only 10-BIT ones are considered in this disclosure.

B. External interface, which is a standard serial port and for which 50 to 200 ports can be supported, and actual chip development can be expanded as required.

C. External interface, which is a USB port 2.0 or a USB port 3.0 and for which up to 200 to 500 ports can be supported as needed, and actual chip development can be expanded as required.

D. External interface, which is an I2C interface and for which 20 to 50 interfaces can be supported, each interface supports XX addresses, and actual chip development can be expanded as required.

E. External interface, which is a SPI interface and for which 20 to 50 interfaces can be supported, and actual chip development can be expanded as required.

F. External interface, which is a single-wire data interface and for which sending data back and forth can be supported, and actual chip development can be expanded as required.

G. External storage interface, which is a SATA and optical fiber interface.

H. External interface, for which a display adopts an HDMI interface and 6 to 20 standard dot matrix display screens can be supported by default, with a refresh frequency not lower than 100 to 200 HZ. Different systems only support several resolutions by default, and other resolutions are supported by software expanding and software splicing.

I. External interface, which is a 10M to 80G optical network interface.

J. Other external interfaces, which is a WAN port and is extended with USB2.0 or USB 3.0.

10. Providing corresponding software virtual machine, in which an old operating system can be run on the machine of this disclosure; and a calculator can manage super-large hardware addressable addresses, and large application software and some data reside in the memory.

11. Cross-platform calling between software, in which with authorization, different software can directly call other software-related interfaces according to addresses in RAM. Calling is performed firstly, and then data is synchronized to external storage or network storage through a relevant process manager. In fact, it becomes a cloud operating system, providing a second-operating experience, even if it is offline, using may not be affected.

12. Designing an operating system with a new architecture and adding a memory address allocation table, in which for large-scale application software, if users desire, RAM with a fixed address can be can allocated to their specific application software, so that large-scale application software allocated with a fixed RAM address can be started in seconds (even if the computer restarts, this part of content residing in memory does not need to be reloaded unless the software fails and needs to be reloaded); and when other software needs to be called or accessed, the fixed memory address can be firstly queried and calling authorization is applied, and reading, writing, modifying and deleting authorization is applied for RAM internal database.

13. Improving existing database and establishing a new database application architecture, in which part of databases resides in memory, and a special chip with a capacity of 10 to 40 GB or more can be even directly provided as a RAM internal database if there is no requirement for cost, and all databases related to personal application software and external databases are copied to an internal database to establish multiple database models (application software defining the database models); and only a part of RAM addresses are allocated as the database when limited in cost, and databases of a network and an external storage are directly copied to the RAM, and firstly, the database is operated quickly in a near end, and then the database automatically transmits and records data to the external storage (a DMA channel is established for the internal database to be stored externally) and network storage is synchronized, but the internal database is directly read and used every time the data is not changed and there is no need to synchronize firstly, thus greatly reducing network data traffic, showing no delay in operating and using, and providing users with ultimate experience.

14. Establishing file indexes of an external storage space in an internal direct addressing space, in which because data and address line bandwidth of the CPU are sufficient, a large amount of data can be stored in the direct addressing space, but some super-large data still need to be stored in external storage devices (such as existing hard disks), so directory indexes of the external file storage can be established synchronously with an external storage in a built-in storage, so that data stored in the external storage can be quickly found and read and written, which will greatly improve a speed of reading, writing and storing operations of the external storage.

### III) Data Storage

1. A decimal data storage mode with a 10-BIT bit width per bit is adopted.

2. A single storage unit can store data and other various symbols.

3. Establishing a new cloud storage and computing system, in which a storage system for a system COPY of a whole computer from file to hardware and synchronous data is established on the network for a personal computer and other common electronic devices to replace a previous network cloud disk so as to ensure security of personal data. Meanwhile, tasks that cannot be completed for the personal computer (such as compilation of Android and LINUX systems, which takes days and nights to complete with the personal computer) can be completed by a larger supercomputer through personal device mapping, so that individuals can use supercomputers, which makes the supercomputers be more fully utilized, makes the individuals work more efficiently, and realize more rational use of social resources and generate economic benefits.

(IV) Data expression and supplementary description, in which the data expression involves digital expression, calculated character expression, operator expression, control symbol expression, Unicode code expression, and other code expression.

a) Decimal Numbers.

| | | Occupancy of 10 BITs | | | | | | | | | |
|---|---|---|---|---|---|---|---|---|---|---|---|
| | Sequence | Ten Digits | | | | | | | | | |
| Indicated Meaning | Number | 9 | 8 | 7 | 6 | 5 | 4 | 3 | 2 | 1 | 0 |
| Null | | | | | | | | | | | |
| 0 (special number, if | 1 | | | | | | | | | | 1 |
| put first, it indicates | | | | | | | | | | | |
| a negative number) | | | | | | | | | | | |
| 1 | 2 | | | | | | | | | 1 | |
| 2 | 3 | | | | | | | | 1 | | |
| 3 | 4 | | | | | | | 1 | | | |
| 4 | 5 | | | | | | 1 | | | | |
| 5 | 6 | | | | | 1 | | | | | |
| 6 | 7 | | | | 1 | | | | | | |
| 7 | 8 | | | 1 | | | | | | | |
| 8 | 9 | | 1 | | | | | | | | |
| 9 | 10 | 1 | | | | | | | | | |
| Isolator (10-bit) | 11 | 1 | 1 | 1 | 1 | 1 | 1 | 1 | 1 | 1 | 1 |

b) Nine-bit operator (with meaning specified when it can be used).

Other unused and undefined nine-bit operators (10 operators) are
temporarily left unused.

| | Sequence | | | | | | | | | | |
|---|---|---|---|---|---|---|---|---|---|---|---|
| Operator Number | Number/Occupancy | Symbol Occupancy | | | | | | | | | |
| Reserved 9-bit | 1*987654321 | 9 | 8 | 7 | 6 | 5 | 4 | 3 | 2 | 1 | |
| Special | | | | | | | | | | | |
| Operators | | | | | | | | | | | |
| Reserved 9-bit | 2*987654320 | 9 | 8 | 7 | 6 | 5 | 4 | 3 | 2 | | 0 |
| Special | | | | | | | | | | | |
| Operators | | | | | | | | | | | |
| Reserved 9-bit | 3*987654310 | 9 | 8 | 7 | 6 | 5 | 4 | 3 | | 1 | 0 |
| Special | | | | | | | | | | | |
| Operators | | | | | | | | | | | |
| Reserved 9-bit | 4*987654210 | 9 | 8 | 7 | 6 | 5 | 4 | | 2 | 1 | 0 |
| Special | | | | | | | | | | | |
| Operators | | | | | | | | | | | |
| Reserved 9-bit | 5*987653210 | 9 | 8 | 7 | 6 | 5 | | 3 | 2 | 1 | 0 |
| Special | | | | | | | | | | | |
| Operators | | | | | | | | | | | |
| Reserved 9-bit | 6*987643210 | 9 | 8 | 7 | 6 | | 4 | 3 | 2 | 1 | 0 |
| Special | | | | | | | | | | | |
| Operators | | | | | | | | | | | |
| Reserved 9-bit | 7*987543210 | 9 | 8 | 7 | | 5 | 4 | 3 | 2 | 1 | 0 |
| Special | | | | | | | | | | | |
| Operators | | | | | | | | | | | |
| Reserved 9-bit | 8*986543210 | 9 | 8 | | 6 | 5 | 4 | 3 | 2 | 1 | 0 |
| Special | | | | | | | | | | | |
| Operators | | | | | | | | | | | |
| Reserved 9-bit | 9*976543210 | 9 | | 7 | 6 | 5 | 4 | 3 | 2 | 1 | 0 |
| Special | | | | | | | | | | | |
| Operators | | | | | | | | | | | |
| Reserved 9-bit | 10*876543210 | | 8 | 7 | 6 | 5 | 4 | 3 | 2 | 1 | 0 |
| Special | | | | | | | | | | | |
| Operators | | | | | | | | | | | |

c) Two-bit combination operator (with meaning specified when it can be used).

Two-bit combination operators (45 operators) are only initially
defined at present, and can be redefined in actual development
program.

| | Sequence | | | | | | | | | | |
|---|---|---|---|---|---|---|---|---|---|---|---|
| Operator Number | Number/Occupancy | Symbol Occupancy | | | | | | | | | |
| Operator 1 | 1*10 | | | | | | | | | 1 | 0 |
| enter | | | | | | | | | | | |
| Operator 2 | 2*20 | | | | | | | | 2 | | 0 |
| decimal point . | | | | | | | | | | | |
| Operator 3 space | 3*30 | | | | | | | 3 | | | 0 |
| Operator 4 plus | 4*40 | | | | | | 4 | | | | 0 |
| sign + | | | | | | | | | | | |
| Operator 5 minus | 5*50 | | | | | 5 | | | | | 0 |
| sign − | | | | | | | | | | | |
| Operator 6 | 6*60 | | | | 6 | | | | | | 0 |
| multiplication | | | | | | | | | | | |
| sign * | | | | | | | | | | | |
| Operator 7 | 7*70 | | | 7 | | | | | | | 0 |
| divide sign ÷ | | | | | | | | | | | |
| Operator 8 | 8*80 | | 8 | | | | | | | | 0 |
| colon : | | | | | | | | | | | |
| Operator 9 | 9*90 | 9 | | | | | | | | | 0 |
| semicolon ; | | | | | | | | | | | |
| Operator 10 / | 10*21 | | | | | | | | 2 | 1 | |
| Operator 11 \ | 11*31 | | | | | | | 3 | | 1 | |
| Operator 12 ( | 12*41 | | | | | | 4 | | | 1 | |
| Operator 13 ) | 13*51 | | | | | 5 | | | | 1 | |
| Operator14 | 14*61 | | | | 6 | | | | | 1 | |
| currency symbol $ | | | | | | | | | | | |
| Operator 15 @ | 15*71 | | | 7 | | | | | | 1 | |
| Operator 16 ~ | 16*81 | | 8 | | | | | | | 1 | |
| Operator 17 | 17*91 | 9 | | | | | | | | 1 | |
| BACKPACE | | | | | | | | | | | |
| Operator 18 # | 18*32 | | | | | | | 3 | 2 | | |
| Operator 19 A, | 19*42 | | | | | | 4 | | 2 | | |
| which is case | | | | | | | | | | | |
| insensitive | | | | | | | | | | | |
| (lowercase typed | | | | | | | | | | | |
| by default) | | | | | | | | | | | |
| Operator 20 B, | 20*52 | | | | | 5 | | | 2 | | |
| which is case | | | | | | | | | | | |
| insensitive | | | | | | | | | | | |
| (lowercase typed | | | | | | | | | | | |
| by default) | | | | | | | | | | | |
| Operator 21 C, | 21*62 | | | | 6 | | | | 2 | | |
| which is case | | | | | | | | | | | |
| insensitive | | | | | | | | | | | |
| (lowercase typed | | | | | | | | | | | |
| by default) | | | | | | | | | | | |
| Operator 22 D, | 22*72 | | | 7 | | | | | 2 | | |
| which is case | | | | | | | | | | | |
| insensitive | | | | | | | | | | | |
| (lowercase typed | | | | | | | | | | | |
| by default) | | | | | | | | | | | |
| Operator 23 E, | 23*82 | | 8 | | | | | | 2 | | |
| which is case | | | | | | | | | | | |
| insensitive | | | | | | | | | | | |
| (lowercase typed | | | | | | | | | | | |
| by default) | | | | | | | | | | | |
| Operator 24 F, | 24*92 | 9 | | | | | | | 2 | | |
| which is case | | | | | | | | | | | |
| insensitive | | | | | | | | | | | |
| (lowercase typed | | | | | | | | | | | |
| by default) | | | | | | | | | | | |
| Operator 25 G, | 25*43 | | | | | | 4 | 3 | | | |
| which is case | | | | | | | | | | | |
| insensitive | | | | | | | | | | | |
| (lowercase typed | | | | | | | | | | | |
| by default) | | | | | | | | | | | |
| Operator 26 H, | 26*53 | | | | | 5 | | 3 | | | |
| which is case | | | | | | | | | | | |
| insensitive | | | | | | | | | | | |
| (lowercase typed | | | | | | | | | | | |
| by default) | | | | | | | | | | | |
| Operator 271, | 27*63 | | | | 6 | | | 3 | | | |
| which is case | | | | | | | | | | | |
| insensitive | | | | | | | | | | | |
| (lowercase typed | | | | | | | | | | | |
| by default) | | | | | | | | | | | |
| Operator 28 J, | 28*73 | | | 7 | | | | 3 | | | |
| which is case | | | | | | | | | | | |
| insensitive | | | | | | | | | | | |
| (lowercase typed | | | | | | | | | | | |
| by default) | | | | | | | | | | | |
| Operator 29 K, | 29*83 | | 8 | | | | | 3 | | | |
| which is case | | | | | | | | | | | |
| insensitive | | | | | | | | | | | |
| (lowercase typed | | | | | | | | | | | |
| by default) | | | | | | | | | | | |
| Operator 30 L, | 30*93 | 9 | | | | | | 3 | | | |
| which is case | | | | | | | | | | | |
| insensitive | | | | | | | | | | | |
| (lowercase typed | | | | | | | | | | | |
| by default) | | | | | | | | | | | |
| Operator 31 M, | 31*54 | | | | | 5 | 4 | | | | |
| which is case | | | | | | | | | | | |
| insensitive | | | | | | | | | | | |
| (lowercase typed | | | | | | | | | | | |
| by default) | | | | | | | | | | | |
| Operator 32 N, | 32*64 | | | | 6 | | 4 | | | | |
| which is case | | | | | | | | | | | |
| insensitive | | | | | | | | | | | |
| (lowercase typed | | | | | | | | | | | |
| by default) | | | | | | | | | | | |
| Operator 33 O, | 33*74 | | | 7 | | | 4 | | | | |
| which is case | | | | | | | | | | | |
| insensitive | | | | | | | | | | | |
| (lowercase typed | | | | | | | | | | | |
| by default) | | | | | | | | | | | |
| Operator 34 P, | 34*84 | | 8 | | | | 4 | | | | |
| which is case | | | | | | | | | | | |
| insensitive | | | | | | | | | | | |
| (lowercase typed | | | | | | | | | | | |
| by default) | | | | | | | | | | | |
| Operator 35 Q, | 35*94 | 9 | | | | | 4 | | | | |
| which is case | | | | | | | | | | | |
| insensitive | | | | | | | | | | | |
| (lowercase typed | | | | | | | | | | | |
| by default) | | | | | | | | | | | |
| Operator 36 R, | 36*65 | | | | 6 | 5 | | | | | |
| which is case | | | | | | | | | | | |
| insensitive | | | | | | | | | | | |
| (lowercase typed | | | | | | | | | | | |
| by default) | | | | | | | | | | | |
| Operator 37 S, | 37*75 | | | 7 | | 5 | | | | | |
| which is case | | | | | | | | | | | |
| insensitive | | | | | | | | | | | |
| (lowercase typed | | | | | | | | | | | |
| by default) | | | | | | | | | | | |
| Operator 38 T, | 38*85 | | 8 | | | 5 | | | | | |
| which is case | | | | | | | | | | | |
| insensitive | | | | | | | | | | | |
| (lowercase typed | | | | | | | | | | | |
| by default) | | | | | | | | | | | |
| Operator 39 U, | 39*95 | 9 | | | | 5 | | | | | |
| which is case | | | | | | | | | | | |
| insensitive | | | | | | | | | | | |
| (lowercase typed | | | | | | | | | | | |
| by default) | | | | | | | | | | | |
| Operator 40 V, | 40*76 | | | 7 | 6 | | | | | | |
| which is case | | | | | | | | | | | |
| insensitive | | | | | | | | | | | |
| (lowercase typed | | | | | | | | | | | |
| by default) | | | | | | | | | | | |
| Operator 41 W, | 41*86 | | 8 | | 6 | | | | | | |
| which is case | | | | | | | | | | | |
| insensitive | | | | | | | | | | | |
| (lowercase typed | | | | | | | | | | | |
| by default) | | | | | | | | | | | |
| Operator 42 X, | 42*96 | 9 | | | 6 | | | | | | |
| which is case | | | | | | | | | | | |
| insensitive | | | | | | | | | | | |
| (lowercase typed | | | | | | | | | | | |
| by default) | | | | | | | | | | | |
| Operator 43 Y, | 43*87 | | 8 | 7 | | | | | | | |
| which is case | | | | | | | | | | | |
| insensitive | | | | | | | | | | | |
| (lowercase typed | | | | | | | | | | | |
| by default) | | | | | | | | | | | |
| Operator 44 Z, | 44*97 | 9 | | 7 | | | | | | | |
| which is case | | | | | | | | | | | |
| insensitive | | | | | | | | | | | |
| (lowercase typed | | | | | | | | | | | |
| by default) | | | | | | | | | | | |
| Operator 45 FN, | 45*98 | 9 | 8 | | | | | | | | |
| which is reserved | | | | | | | | | | | |
| (original | | | | | | | | | | | |
| definition is | | | | | | | | | | | |
| changed) | | | | | | | | | | | |

d) Eight-bit combination operator (with meaning specified when it can be used).

Undefined eight-bit operators (45 operators) (which are initially defined
at present, but can be redefined in actual development program).
It is recommended to be used as an operation control symbol.

| | Sequence | | | | | | | | | | |
|---|---|---|---|---|---|---|---|---|---|---|---|
| Operator Number | Number/Occupancy | Symbol Occupancy | | | | | | | | | |
| Operator 1* Basic | 1*98765432 | 9 | 8 | 7 | 6 | 5 | 4 | 3 | 2 | | |
| program control | | | | | | | | | | | |
| statement FOR | | | | | | | | | | | |
| Operator 2* Basic | 2*98765431 | 9 | 8 | 7 | 6 | 5 | 4 | 3 | | 1 | |
| program control | | | | | | | | | | | |
| statement IF | | | | | | | | | | | |
| Operator 3* Basic | 3*98765421 | 9 | 8 | 7 | 6 | 5 | 4 | | 2 | 1 | |
| program control | | | | | | | | | | | |
| statement WILE | | | | | | | | | | | |
| Operator 4* Basic | 4*98765321 | 9 | 8 | 7 | 6 | 5 | | 3 | 2 | 1 | |
| program control | | | | | | | | | | | |
| statement NONE | | | | | | | | | | | |
| Operator 5* Basic | 5*98764321 | 9 | 8 | 7 | 6 | | 4 | 3 | 2 | 1 | |
| program control | | | | | | | | | | | |
| statement TRUE | | | | | | | | | | | |
| Operator 6* Basic | 6*98754321 | 9 | 8 | 7 | | 5 | 4 | 3 | 2 | 1 | |
| program control | | | | | | | | | | | |
| statement AND | | | | | | | | | | | |
| Operator 7* Basic | 7*98654321 | 9 | 8 | | 6 | 5 | 4 | 3 | 2 | 1 | |
| program control | | | | | | | | | | | |
| statement AS | | | | | | | | | | | |
| Operator 8* Basic | 8*97654321 | 9 | | 7 | 6 | 5 | 4 | 3 | 2 | 1 | |
| program control | | | | | | | | | | | |
| statement BREAK | | | | | | | | | | | |
| Operator 9* Basic | 9*87654321 | | 8 | 7 | 6 | 5 | 4 | 3 | 2 | 1 | |
| program control | | | | | | | | | | | |
| statement CLASS | | | | | | | | | | | |
| Operator 10* Basic | 10*98765430 | 9 | 8 | 7 | 6 | 5 | 4 | 3 | | | 0 |
| program control | | | | | | | | | | | |
| statement DEF | | | | | | | | | | | |
| Operator 11* Basic | 11*98765420 | 9 | 8 | 7 | 6 | 5 | 4 | | 2 | | 0 |
| program control | | | | | | | | | | | |
| statement ELIF | | | | | | | | | | | |
| Operator 12* Basic | 12*98765320 | 9 | 8 | 7 | 6 | 5 | | 3 | 2 | | 0 |
| program control | | | | | | | | | | | |
| statement IMPORT | | | | | | | | | | | |
| Operator 13* Basic | 13*98764320 | 9 | 8 | 7 | 6 | | 4 | 3 | 2 | | 0 |
| program control | | | | | | | | | | | |
| statement GLOBAL | | | | | | | | | | | |
| Operator 14* Basic | 14*98754320 | 9 | 8 | 7 | | 5 | 4 | 3 | 2 | | 0 |
| program control | | | | | | | | | | | |
| statement IN | | | | | | | | | | | |
| Operator 15* Basic | 15*98654320 | 9 | 8 | | 6 | 5 | 4 | 3 | 2 | | 0 |
| program control | | | | | | | | | | | |
| statement IS | | | | | | | | | | | |
| Operator 16* Basic | 16*97654320 | 9 | | 7 | 6 | 5 | 4 | 3 | 2 | | 0 |
| program control | | | | | | | | | | | |
| statement NOT | | | | | | | | | | | |
| Operator 17* Basic | 17*87654320 | | 8 | 7 | 6 | 5 | 4 | 3 | 2 | | 0 |
| program control | | | | | | | | | | | |
| statement OR | | | | | | | | | | | |
| Operator 18* Basic | 18*98765410 | 9 | 8 | 7 | 6 | 5 | 4 | | | 1 | 0 |
| program control | | | | | | | | | | | |
| statement PASS | | | | | | | | | | | |
| Operator 19* Basic | 19*98765310 | 9 | 8 | 7 | 6 | 5 | | 3 | | 1 | 0 |
| program control | | | | | | | | | | | |
| statement TRY | | | | | | | | | | | |
| Operator 20* Basic | 20*98764310 | 9 | 8 | 7 | 6 | | 4 | 3 | | 1 | 0 |
| program control | | | | | | | | | | | |
| statement WITH | | | | | | | | | | | |
| Operator 21* Basic | 21*98754310 | 9 | 8 | 7 | | 5 | 4 | 3 | | 1 | 0 |
| program control | | | | | | | | | | | |
| statement YIELD | | | | | | | | | | | |
| Operator 22* Basic | 22*98654310 | 9 | 8 | | 6 | 5 | 4 | 3 | | 1 | 0 |
| program control | | | | | | | | | | | |
| statement RETURN | | | | | | | | | | | |
| Operator 23* Basic | 23*97654310 | 9 | | 7 | 6 | 5 | 4 | 3 | | 1 | 0 |
| program control | | | | | | | | | | | |
| statement ADDRESS | | | | | | | | | | | |
| Operator 24* Basic | 24*87654310 | | 8 | 7 | 6 | 5 | 4 | 3 | | 1 | 0 |
| program control | | | | | | | | | | | |
| statement | | | | | | | | | | | |
| Operator 25* Basic | 25*98765210 | 9 | 8 | 7 | 6 | 5 | | | 2 | 1 | 0 |
| program control | | | | | | | | | | | |
| statement | | | | | | | | | | | |
| Operator 26* Basic | 26*98764210 | 9 | 8 | 7 | 6 | | 4 | | 2 | 1 | 0 |
| program control | | | | | | | | | | | |
| statement | | | | | | | | | | | |
| Operator 27* Basic | 27*98754210 | 9 | 8 | 7 | | 5 | 4 | | 2 | 1 | 0 |
| program control | | | | | | | | | | | |
| statement | | | | | | | | | | | |
| Operator 28* Basic | 28*98654210 | 9 | 8 | | 6 | 5 | 4 | | 2 | 1 | 0 |
| program control | | | | | | | | | | | |
| statement | | | | | | | | | | | |
| Operator 29* Basic | 29*97654210 | 9 | | 7 | 6 | 5 | 4 | | 2 | 1 | 0 |
| program control | | | | | | | | | | | |
| statement | | | | | | | | | | | |
| Operator 30* Basic | 30*87654210 | | 8 | 7 | 6 | 5 | 4 | | 2 | 1 | 0 |
| program control | | | | | | | | | | | |
| statement | | | | | | | | | | | |
| Operator 31* Basic | 31*98763210 | 9 | 8 | 7 | 6 | | | 3 | 2 | 1 | 0 |
| program control | | | | | | | | | | | |
| statement | | | | | | | | | | | |
| Operator 32* Basic | 32*98753210 | 9 | 8 | 7 | | 5 | | 3 | 2 | 1 | 0 |
| program control | | | | | | | | | | | |
| statement | | | | | | | | | | | |
| Operator 33* Basic | 33*98653210 | 9 | 8 | | 6 | 5 | | 3 | 2 | 1 | 0 |
| program control | | | | | | | | | | | |
| statement | | | | | | | | | | | |
| Operator 34* Basic | 34*97653210 | 9 | | 7 | 6 | 5 | | 3 | 2 | 1 | 0 |
| program control | | | | | | | | | | | |
| statement | | | | | | | | | | | |
| Operator 35* Basic | 35*87653210 | | 8 | 7 | 6 | 5 | | 3 | 2 | 1 | 0 |
| program control | | | | | | | | | | | |
| statement | | | | | | | | | | | |
| Operator 36* Basic | 36*98743210 | 9 | 8 | 7 | | | 4 | 3 | 2 | 1 | 0 |
| program control | | | | | | | | | | | |
| statement | | | | | | | | | | | |
| Operator 37* Basic | 37*98643210 | 9 | 8 | | 6 | | 4 | 3 | 2 | 1 | 0 |
| program control | | | | | | | | | | | |
| statement | | | | | | | | | | | |
| Operator 38* Basic | 38*97643210 | 9 | | 7 | 6 | | 4 | 3 | 2 | 1 | 0 |
| program control | | | | | | | | | | | |
| statement | | | | | | | | | | | |
| Operator 39* Basic | 39*87643210 | | 8 | 7 | 6 | | 4 | 3 | 2 | 1 | 0 |
| program control | | | | | | | | | | | |
| statement | | | | | | | | | | | |
| Operator 40* Basic | 40*98543210 | 9 | 8 | | | 5 | 4 | 3 | 2 | 1 | |
| program control | | | | | | | | | | | |
| statement | | | | | | | | | | | |
| Operator 41* Basic | 41*97543210 | 9 | | 7 | | 5 | 4 | 3 | 2 | 1 | 0 |
| program control | | | | | | | | | | | |
| statement | | | | | | | | | | | |
| Operator 42* Basic | 42*87543210 | | 8 | 7 | | 5 | 4 | 3 | 2 | 1 | 0 |
| program control | | | | | | | | | | | |
| statement | | | | | | | | | | | |
| Operator 43* Basic | 43*96543210 | 9 | | | 6 | 5 | 4 | 3 | 2 | 1 | 0 |
| program control | | | | | | | | | | | |
| statement | | | | | | | | | | | |
| Operator 44* Basic | 44*86543210 | | 8 | | 6 | 5 | 4 | 3 | 2 | 1 | 0 |
| program control | | | | | | | | | | | |
| statement | | | | | | | | | | | |
| Operator 45* Basic | 45*76543210 | | | 7 | 6 | 5 | 4 | 3 | 2 | 1 | 0 |
| program control | | | | | | | | | | | |
| statement | | | | | | | | | | | |

E) Three-bit combination operator (120 bits in total) (with meaning determined when it can be used).

| | | |
|---|---|---|
| Example of operation | | |
| control symbol | Sequence | |
| number | Number/Occupancy | Symbol Occupancy |

Undefined operator to be extended Three-bit combination operator
(120 operators) (36-bit primary operators)

| | | | | | | | | | | | |
|---|---|---|---|---|---|---|---|---|---|---|---|
| Operator 46 (operator | 46*210 | | | | | | | | 2 | 1 | 0 |
| to be extended) XOR | | | | | | | | | | | |
| Operator 47 (operator | 47*310 | | | | | | | 3 | | 1 | 0 |
| to be extended) AND | | | | | | | | | | | |
| Operator 48 (operator | 48*410 | | | | | | 4 | | | 1 | 0 |
| to be extended) OR | | | | | | | | | | | |
| Operator 49 (operator | 49*510 | | | | | 5 | | | | 1 | 0 |
| to be extended) | | | | | | | | | | | |
| Operator 50 (operator | 50*610 | | | | 6 | | | | | 1 | 0 |
| to be extended) | | | | | | | | | | | |
| Operator 51 (operator | 51*710 | | | 7 | | | | | | 1 | 0 |
| to be extended) | | | | | | | | | | | |
| Operator 52 (operator | 52*810 | | 8 | | | | | | | 1 | 0 |
| to be extended) | | | | | | | | | | | |
| Operator 53 (operator | 53*910 | 9 | | | | | | | | 1 | 0 |
| to be extended) | | | | | | | | | | | |
| Operator 54 (operator | 54*320 | | | | | | | 3 | 2 | | 0 |
| to be extended) | | | | | | | | | | | |
| Operator 55 (operator | 55*420 | | | | | | 4 | | 2 | | 0 |
| to be extended) | | | | | | | | | | | |
| Operator 56 (operator | 56*520 | | | | | 5 | | | 2 | | 0 |
| to be extended) | | | | | | | | | | | |
| Operator 57 (operator | 57*620 | | | | 6 | | | | 2 | | 0 |
| to be extended) | | | | | | | | | | | |
| Operator 58 (operator | 58*720 | | | 7 | | | | | 2 | | 0 |
| to be extended) | | | | | | | | | | | |
| Operator 59 (operator | 59*820 | | 8 | | | | | | 2 | | 0 |
| to be extended) | | | | | | | | | | | |
| Operator 60 (operator | 60*920 | 9 | | | | | | | 2 | | 0 |
| to be extended) | | | | | | | | | | | |
| Operator 61 (operator | 61*430 | | | | | | 4 | 3 | | | 0 |
| to be extended) | | | | | | | | | | | |
| Operator 62 (operator | 62*530 | | | | | 5 | | 3 | | | 0 |
| to be extended) | | | | | | | | | | | |
| Operator 63 (operator | 63*630 | | | | 6 | | | 3 | | | 0 |
| to be extended) | | | | | | | | | | | |
| Operator 64 (operator | 64*730 | | | 7 | | | | 3 | | | 0 |
| to be extended) | | | | | | | | | | | |
| Operator 65 (operator | 65*830 | | 8 | | | | | 3 | | | 0 |
| to be extended) | | | | | | | | | | | |
| Operator 66 (operator | 66*930 | 9 | | | | | | 3 | | | 0 |
| to be extended) | | | | | | | | | | | |
| Operator 67 (operator | 67*540 | | | | | 5 | 4 | | | | 0 |
| to be extended) | | | | | | | | | | | |
| Operator 68 (operator | 68*640 | | | | 6 | | 4 | | | | 0 |
| to be extended) | | | | | | | | | | | |
| Operator 69 (operator | 69*740 | | | 7 | | | 4 | | | | 0 |
| to be extended) | | | | | | | | | | | |
| Operator 70 (operator | 70*840 | | 8 | | | | 4 | | | | 0 |
| to be extended) | | | | | | | | | | | |
| Operator 71 (operator | 71*940 | 9 | | | | | 4 | | | | 0 |
| to be extended) | | | | | | | | | | | |
| Operator 72 (operator | 72*650 | | | | 6 | 5 | | | | | 0 |
| to be extended) | | | | | | | | | | | |
| Operator 73 (operator | 73*750 | | | 7 | | 5 | | | | | 0 |
| to be extended) | | | | | | | | | | | |
| Operator 74 (operator | 74*850 | | 8 | | | 5 | | | | | 0 |
| to be extended) | | | | | | | | | | | |
| Operator 75 (operator | 75*950 | 9 | | | | 5 | | | | | 0 |
| to be extended) | | | | | | | | | | | |
| Operator 76 (operator | 76*760 | | | 7 | 6 | | | | | | 0 |
| to be extended) | | | | | | | | | | | |
| Operator 77 (operator | 77*860 | | 8 | | 6 | | | | | | 0 |
| to be extended) | | | | | | | | | | | |
| Operator 78 (operator | 78*960 | 9 | | | 6 | | | | | | 0 |
| to be extended) | | | | | | | | | | | |
| Operator 79 (operator | 79*870 | | 8 | 7 | | | | | | | 0 |
| to be extended) | | | | | | | | | | | |
| Operator 80 (operator | 80*970 | 9 | | 7 | | | | | | | 0 |
| to be extended) | | | | | | | | | | | |
| Operator 81 (operator | 81*980 | 9 | 8 | | | | | | | | 0 |
| to be extended) | | | | | | | | | | | |

Other Operators undefined Three-bit combination operator (120
operators) (84-bit advanced operators)

| | | | | | | | | | | |
|---|---|---|---|---|---|---|---|---|---|---|
| Operator 82 (operator | 82*321 | | | | | | | 3 | 2 | 1 |
| to be extended) | | | | | | | | | | |
| Operator 83 (operator | 83*421 | | | | | | 4 | | 2 | 1 |
| to be extended) | | | | | | | | | | |
| Operator 84 (operator | 84*521 | | | | | 5 | | | 2 | 1 |
| to be extended) | | | | | | | | | | |
| Operator 85 (operator | 85*621 | | | | 6 | | | | 2 | 1 |
| to be extended) | | | | | | | | | | |
| Operator 86 (operator | 86*721 | | | 7 | | | | | 2 | 1 |
| to be extended) | | | | | | | | | | |
| Operator 87 (operator | 87*821 | | 8 | | | | | | 2 | 1 |
| to be extended) | | | | | | | | | | |
| Operator 88 (operator | 88*921 | 9 | | | | | | | 2 | 1 |
| to be extended) | | | | | | | | | | |
| Operator 89 (operator | 89*431 | | | | | | 4 | 3 | | 1 |
| to be extended) | | | | | | | | | | |
| Operator 90 (operator | 90*531 | | | | | 5 | | 3 | | 1 |
| to be extended) | | | | | | | | | | |
| Operator 91 (operator | 91*631 | | | | 6 | | | 3 | | 1 |
| to be extended) | | | | | | | | | | |
| Operator 92 (operator | 92*731 | | | 7 | | | | 3 | | 1 |
| to be extended) | | | | | | | | | | |
| Operator 93 (operator | 93*831 | | 8 | | | | | 3 | | 1 |
| to be extended) | | | | | | | | | | |
| Operator 94 (operator | 94*931 | 9 | | | | | | 3 | | 1 |
| to be extended) | | | | | | | | | | |
| Operator 95 (operator | 95*541 | | | | | 5 | 4 | | | 1 |
| to be extended) | | | | | | | | | | |
| Operator 96 (operator | 96*641 | | | | 6 | | 4 | | | 1 |
| to be extended) | | | | | | | | | | |
| Operator 97 (operator | 97*741 | | | 7 | | | 4 | | | 1 |
| to be extended) | | | | | | | | | | |
| Operator 98 (operator | 98*841 | | 8 | | | | 4 | | | 1 |
| to be extended) | | | | | | | | | | |
| Operator 99 (operator | 99*941 | 9 | | | | | 4 | | | 1 |
| to be extended) | | | | | | | | | | |
| Operator 100 | 100*651 | | | | 6 | 5 | | | | 1 |
| (operator to be | | | | | | | | | | |
| extended) | | | | | | | | | | |
| Operator 101 | 101*751 | | | 7 | | 5 | | | | 1 |
| (operator to be | | | | | | | | | | |
| extended) | | | | | | | | | | |
| Operator102 | 102*851 | | 8 | | | 5 | | | | 1 |
| (operator to be | | | | | | | | | | |
| extended) | | | | | | | | | | |
| Operator 103 | 103*951 | 9 | | | | 5 | | | | 1 |
| (operator to be | | | | | | | | | | |
| extended) | | | | | | | | | | |
| Operator 104 | 104*761 | | | 7 | 6 | | | | | 1 |
| (operator to be | | | | | | | | | | |
| extended) | | | | | | | | | | |
| Operator105 | 105*861 | | 8 | | 6 | | | | | 1 |
| (operator to be | | | | | | | | | | |
| extended) | | | | | | | | | | |
| Operator 106 | 106*961 | 9 | | | 6 | | | | | 1 |
| (operator to be | | | | | | | | | | |
| extended) | | | | | | | | | | |
| Operator 107 | 107*871 | | 8 | 7 | | | | | | 1 |
| (operator to be | | | | | | | | | | |
| extended) | | | | | | | | | | |
| Operator 108 | 108*971 | 9 | | 7 | | | | | | 1 |
| (operator to be | | | | | | | | | | |
| extended) | | | | | | | | | | |
| Operator 109 | 109*981 | 9 | 8 | | | | | | | 1 |
| (operator to be | | | | | | | | | | |
| extended) | | | | | | | | | | |
| Operator 110 | 110*432 | | | | | | 4 | 3 | 2 | |
| (operator to be | | | | | | | | | | |
| extended) | | | | | | | | | | |
| Operator 111 | 111*532 | | | | | 5 | | 3 | 2 | |
| (operator to be | | | | | | | | | | |
| extended) | | | | | | | | | | |
| Operator 112 | 112*632 | | | | 6 | | | 3 | 2 | |
| (operator to be | | | | | | | | | | |
| extended) | | | | | | | | | | |
| Operator 113 | 113*732 | | | 7 | | | | 3 | 2 | |
| (operator to be | | | | | | | | | | |
| extended) | | | | | | | | | | |
| Operator 114 | 114*832 | | 8 | | | | | 3 | 2 | |
| (operator to be | | | | | | | | | | |
| extended) | | | | | | | | | | |
| Operator 115 | 115*932 | 9 | | | | | | 3 | 2 | |
| (operator to be | | | | | | | | | | |
| extended) | | | | | | | | | | |
| Operator 116 | 116*542 | | | | | 5 | 4 | | 2 | |
| (operator to be | | | | | | | | | | |
| extended) | | | | | | | | | | |
| Operator 117 | 117*642 | | | | 6 | | 4 | | 2 | |
| (operator to be | | | | | | | | | | |
| extended) | | | | | | | | | | |
| Operator 118 | 118*742 | | | 7 | | | 4 | | 2 | |
| (operator to be | | | | | | | | | | |
| extended) | | | | | | | | | | |
| Operator 119 | 119*842 | | 8 | | | | 4 | | 2 | |
| (operator to be | | | | | | | | | | |
| extended) | | | | | | | | | | |
| Operator 120 | 120*942 | 9 | | | | | 4 | | 2 | |
| (operator to be | | | | | | | | | | |
| extended) | | | | | | | | | | |
| Operator 121 | 121*652 | | | | 6 | 5 | | | 2 | |
| (operator to be | | | | | | | | | | |
| extended) | | | | | | | | | | |
| Operator 122 | 122*752 | | | 7 | | 5 | | | 2 | |
| (operator to be | | | | | | | | | | |
| extended) | | | | | | | | | | |
| Operator 123 | 123*852 | | 8 | | | 5 | | | 2 | |
| (operator to be | | | | | | | | | | |
| extended) | | | | | | | | | | |
| Operator 124 | 124*952 | 9 | | | | 5 | | | 2 | |
| (operator to be | | | | | | | | | | |
| extended) | | | | | | | | | | |
| Operator 125 | 125*762 | | | 7 | 6 | | | | 2 | |
| (operator to be | | | | | | | | | | |
| extended) | | | | | | | | | | |
| Operator 126 | 126*862 | | 8 | | 6 | | | | 2 | |
| (operator to be | | | | | | | | | | |
| extended) | | | | | | | | | | |
| Operator127 | 127*962 | 9 | | | 6 | | | | 2 | |
| (operator to be | | | | | | | | | | |
| extended) | | | | | | | | | | |
| Operator128 | 128*872 | | 8 | 7 | | | | | 2 | |
| (operator to be | | | | | | | | | | |
| extended) | | | | | | | | | | |
| Operator129 | 129*972 | 9 | | 7 | | | | | 2 | |
| (operator to be | | | | | | | | | | |
| extended) | | | | | | | | | | |
| Operator 130 | 130*982 | 9 | 8 | | | | | | 2 | |
| (operator to be | | | | | | | | | | |
| extended) | | | | | | | | | | |
| Operator 131 | 131*543 | | | | | 5 | 4 | 3 | | |
| (operator to be | | | | | | | | | | |
| extended) | | | | | | | | | | |
| Operator 132 | 132*643 | | | | 6 | | 4 | 3 | | |
| (operator to be | | | | | | | | | | |
| extended) | | | | | | | | | | |
| Operator 133 | 133*743 | | | 7 | | | 4 | 3 | | |
| (operator to be | | | | | | | | | | |
| extended) | | | | | | | | | | |
| Operator 134 | 134*843 | | 8 | | | | 4 | 3 | | |
| (operator to be | | | | | | | | | | |
| extended) | | | | | | | | | | |
| Operator 135 | 135*943 | 9 | | | | | 4 | 3 | | |
| (operator to be | | | | | | | | | | |
| extended) | | | | | | | | | | |
| Operator 136 | 136*653 | | | | 6 | 5 | | 3 | | |
| (operator to be | | | | | | | | | | |
| extended) | | | | | | | | | | |
| Operator 137 | 137*753 | | | 7 | | 5 | | 3 | | |
| (operator to be | | | | | | | | | | |
| extended) | | | | | | | | | | |
| Operator 138 | 138*853 | | 8 | | | 5 | | 3 | | |
| (operator to be | | | | | | | | | | |
| extended) | | | | | | | | | | |
| Operator 139 | 139*953 | 9 | | | | 5 | | 3 | | |
| (operator to be | | | | | | | | | | |
| extended) | | | | | | | | | | |
| Operator 140 | 140*763 | | | 7 | 6 | | | 3 | | |
| (operator to be | | | | | | | | | | |
| extended) | | | | | | | | | | |
| Operator 141 | 141*863 | | 8 | | 6 | | | 3 | | |
| (operator to be | | | | | | | | | | |
| extended) | | | | | | | | | | |
| Operator 142 | 142*963 | 9 | | | 6 | | | 3 | | |
| (operator to be | | | | | | | | | | |
| extended) | | | | | | | | | | |
| Operator 143 | 143*873 | | 8 | 7 | | | | 3 | | |
| (operator to be | | | | | | | | | | |
| extended) | | | | | | | | | | |
| Operator 144 | 144*973 | 9 | | 7 | | | | 3 | | |
| (operator to be | | | | | | | | | | |
| extended) | | | | | | | | | | |
| Operator 145 | 145*983 | 9 | 8 | | | | | 3 | | |
| (operator to be | | | | | | | | | | |
| extended) | | | | | | | | | | |
| Operator 146 | 146*654 | | | | 6 | 5 | 4 | | | |
| (operator to be | | | | | | | | | | |
| extended) | | | | | | | | | | |
| Operator 147 | 147*754 | | | 7 | | 5 | 4 | | | |
| (operator to be | | | | | | | | | | |
| extended) | | | | | | | | | | |
| Operator 148 | 148*854 | | 8 | | | 5 | 4 | | | |
| (operator to be | | | | | | | | | | |
| extended) | | | | | | | | | | |
| Operator 149 | 149*954 | 9 | | | | 5 | 4 | | | |
| (operator to be | | | | | | | | | | |
| extended) | | | | | | | | | | |
| Operator 150 | 150*764 | | | 7 | 6 | | 4 | | | |
| (operator to be | | | | | | | | | | |
| extended) | | | | | | | | | | |
| Operator 151 | 151*864 | | 8 | | 6 | | 4 | | | |
| (operator to be | | | | | | | | | | |
| extended) | | | | | | | | | | |
| Operator 152 | 152*964 | 9 | | | 6 | | 4 | | | |
| (operator to be | | | | | | | | | | |
| extended) | | | | | | | | | | |
| Operator 153 | 153*874 | | 8 | 7 | | | 4 | | | |
| (operator to be | | | | | | | | | | |
| extended) | | | | | | | | | | |
| Operator 154 | 154*974 | 9 | | 7 | | | 4 | | | |
| (operator to be | | | | | | | | | | |
| extended) | | | | | | | | | | |
| Operator 155 | 155*984 | 9 | 8 | | | | 4 | | | |
| (operator to be | | | | | | | | | | |
| extended) | | | | | | | | | | |
| Operator 156 | 156*765 | | | 7 | 6 | 5 | | | | |
| (operator to be | | | | | | | | | | |
| extended) | | | | | | | | | | |
| Operator 157 | 157*865 | | 8 | | 6 | 5 | | | | |
| (operator to be | | | | | | | | | | |
| extended) | | | | | | | | | | |
| Operator 158 | 158*965 | 9 | | | 6 | 5 | | | | |
| (operator to be | | | | | | | | | | |
| extended) | | | | | | | | | | |
| Operator 159 | 159*875 | | 8 | 7 | | 5 | | | | |
| (operator to be | | | | | | | | | | |
| extended) | | | | | | | | | | |
| Operator 160 | 160*975 | 9 | | 7 | | 5 | | | | |
| (operator to be | | | | | | | | | | |
| extended) | | | | | | | | | | |
| Operator 161 | 161*985 | 9 | 8 | | | 5 | | | | |
| (operator to be | | | | | | | | | | |
| extended) | | | | | | | | | | |
| Operator 162 | 162*876 | | 8 | 7 | 6 | | | | | |
| (operator to be | | | | | | | | | | |
| extended) | | | | | | | | | | |
| Operator 163 | 163*976 | 9 | | 7 | 6 | | | | | |
| (operator to be | | | | | | | | | | |
| extended) | | | | | | | | | | |
| Operator 164 | 164*986 | 9 | 8 | | 6 | | | | | |
| (operator to be | | | | | | | | | | |
| extended) | | | | | | | | | | |
| Operator 165 | 165*987 | 9 | 8 | 7 | | | | | | |
| (operator to be | | | | | | | | | | |
| extended) | | | | | | | | | | |

f) four-bit, five-bit or six-bit operators are combined into a Uicode code (meaning of the code can be determined when specifically used).

| | | |
|---|---|---|
| Regarding uses | | |
| examples, it is | | |
| currently | | |
| recommended to use | | |
| as the UNICODE | Sequence | Symbol Occupancy (undefined and |
| code. | Number/Occupancy | can be defined subsequently) |

Unused and undefined four-bit operators (210 operators) are currently as
the Unicode code.

| | | | | | | | | | |
|---|---|---|---|---|---|---|---|---|---|
| uses examples, which | 1*3210 | | | | | 3 | 2 | 1 | 0 |
| can be changed | | | | | | | | | |
| practically | | | | | | | | | |
| uses examples, which | 2*4210 | | | | 4 | | 2 | 1 | 0 |
| can be changed | | | | | | | | | |
| practically | | | | | | | | | |
| uses examples, which | 3*5210 | | | 5 | | | 2 | 1 | 0 |
| can be changed | | | | | | | | | |
| practically | | | | | | | | | |
| uses examples, which | 4*6210 | | 6 | | | | 2 | 1 | 0 |
| can be changed | | | | | | | | | |
| practically | | | | | | | | | |
| uses examples, which | 5*7210 | 7 | | | | | 2 | 1 | 0 |
| can be changed | | | | | | | | | |
| practically | | | | | | | | | |
| . . . | | | | | | | | | |
| . . . | | | | | | | | | |
| . . . Undefined | N* . . . | | | | | | | | |

Unused and undefined five-bit operators (252 operators) are currently as
the Unicode code.

| | | | | | | | | | | | |
|---|---|---|---|---|---|---|---|---|---|---|---|
| uses examples, which | 1*543210 | | | | | | 4 | 3 | 2 | 1 | 0 |
| can be changed | | | | | | | | | | | |
| practically | | | | | | | | | | | |
| uses examples, which | 2 | | | | | 5 | | 3 | 2 | 1 | 0 |
| can be changed | | | | | | | | | | | |
| practically | | | | | | | | | | | |
| | 3 | | | | 6 | | | 3 | 2 | 1 | 0 |
| | 4 | | | 7 | | | | 3 | 2 | 1 | 0 |
| | 5 | | 8 | | | | | 3 | 2 | 1 | 0 |
| | 6 | 9 | | | | | | 3 | 2 | 1 | 0 |

Unused and undefined six-bit operators (210 operators) are currently as
the Unicode code.

| | | | | | | | | |
|---|---|---|---|---|---|---|---|---|
| uses examples, which | 1*987654 | 9 | 8 | 7 | 6 | 5 | 4 | |
| can be changed | | | | | | | | |
| practically | | | | | | | | |
| uses examples, which | 2*987653 | 9 | 8 | 7 | 6 | 5 | | 3 |
| can be changed | | | | | | | | |
| practically | | | | | | | | |
| uses examples, which | 3*987643 | 9 | 8 | 7 | 6 | | 4 | 3 |
| can be changed | | | | | | | | |
| practically | | | | | | | | |
| uses examples, which | 4*987543 | 9 | 8 | 7 | | 5 | 4 | 3 |
| can be changed | | | | | | | | |
| practically | | | | | | | | |
| uses examples, | 5*986543 | 9 | 8 | | 6 | 5 | 4 | 3 |
| which can be | | | | | | | | |
| changed practically | | | | | | | | |
| uses examples, | 6*976543 | 9 | | 7 | 6 | 5 | 4 | 3 |
| which can be | | | | | | | | |
| changed practically | | | | | | | | |
| uses examples, | 7*876543 | | 8 | 7 | 6 | 5 | 4 | 3 |
| which can be | | | | | | | | |
| changed practically | | | | | | | | |
| . . . | | | | | | | | |
| . . . Undefined | N* . . . | | | | | | | |

g) Seven-bit combination operators and control symbols (120 in total, for which specific meaning can be determined when used).

Other unused and undefined seven-bit operators (120 operators)

| Example of operator | Sequence | | | | | | | | | | |
|---|---|---|---|---|---|---|---|---|---|---|---|
| number definition | Number/Occupancy | Symbol Occupancy | | | | | | | | | |
| (operator to be | 1*9876543 | 9 | 8 | 7 | 6 | 5 | 4 | 3 | | | |
| extended) * for | | | | | | | | | | | |
| example: Http: | | | | | | | | | | | |
| (operator to be | 2*9876542 | 9 | 8 | 7 | 6 | 5 | 4 | | 2 | | |
| extended) * for | | | | | | | | | | | |
| example: Https: | | | | | | | | | | | |
| (operator to be | 3*9876532 | 9 | 8 | 7 | 6 | 5 | | 3 | 2 | | |
| extended) * for | | | | | | | | | | | |
| example: www. | | | | | | | | | | | |
| (operator to be | 4*9876432 | 9 | 8 | 7 | 6 | | 4 | 3 | 2 | | |
| extended) * for | | | | | | | | | | | |
| example: Tel: | | | | | | | | | | | |
| (operator to be | 5*9875432 | 9 | 8 | 7 | | 5 | 4 | 3 | 2 | | |
| extended) * for | | | | | | | | | | | |
| example, function: | | | | | | | | | | | |
| sum: | | | | | | | | | | | |
| (operator to be | 6*9865432 | 9 | 8 | | 6 | 5 | 4 | 3 | 2 | | |
| extended) * for | | | | | | | | | | | |
| example, function: | | | | | | | | | | | |
| abs: | | | | | | | | | | | |
| (operator to be | 7*9765432 | 9 | | 7 | 6 | 5 | 4 | 3 | 2 | | |
| extended) * for | | | | | | | | | | | |
| example, function: | | | | | | | | | | | |
| sum: | | | | | | | | | | | |
| (operator to be | 8*8765432 | | 8 | 7 | 6 | 5 | 4 | 3 | 2 | | |
| extended) * | | | | | | | | | | | |
| (operator to be | 9*9876541 | 9 | 8 | 7 | 6 | 5 | 4 | | | 1 | |
| extended) * | | | | | | | | | | | |
| (operator to be | 10*9876531 | 9 | 8 | 7 | 6 | 5 | | 3 | | 1 | |
| extended) * | | | | | | | | | | | |
| (operator to be | 11*9876431 | 9 | 8 | 7 | 6 | | 4 | 3 | | 1 | |
| extended) * | | | | | | | | | | | |
| (operator to be | 12*9875431 | 9 | 8 | 7 | | 5 | 4 | 3 | | 1 | |
| extended) * | | | | | | | | | | | |
| (operator to be | 13*9865431 | 9 | 8 | | 6 | 5 | 4 | 3 | | 1 | |
| extended) * | | | | | | | | | | | |
| (operator to be | 14*9765431 | 9 | | 7 | 6 | 5 | 4 | 3 | | 1 | |
| extended) * | | | | | | | | | | | |
| (operator to be | 15*8765431 | | 8 | 7 | 6 | 5 | 4 | 3 | | 1 | |
| extended) * | | | | | | | | | | | |
| (operator to be | 16*9876521 | 9 | 8 | 7 | 6 | 5 | | | 2 | 1 | |
| extended) * | | | | | | | | | | | |
| (operator to be | 17*9876421 | 9 | 8 | 7 | 6 | | 4 | | 2 | 1 | |
| extended) * | | | | | | | | | | | |
| (operator to be | 18*9875421 | 9 | 8 | 7 | | 5 | 4 | | 2 | 1 | |
| extended) * | | | | | | | | | | | |
| (operator to be | 19*9865421 | 9 | 8 | | 6 | 5 | 4 | | 2 | 1 | |
| extended) * | | | | | | | | | | | |
| (operator to be | 20*9765421 | 9 | | 7 | 6 | 5 | 4 | | 2 | 1 | |
| extended) * | | | | | | | | | | | |
| (operator to be | 21*8765421 | | 8 | 7 | 6 | 5 | 4 | | 2 | 1 | |
| extended) * | | | | | | | | | | | |
| (operator to be | 22*9876321 | 9 | 8 | 7 | 6 | | | 3 | 2 | 1 | |
| extended) * | | | | | | | | | | | |
| (operator to be | 23*9875321 | 9 | 8 | 7 | | 5 | | 3 | 2 | 1 | |
| extended) * | | | | | | | | | | | |
| (operator to be | 24*9865321 | 9 | 8 | | 6 | 5 | | 3 | 2 | 1 | |
| extended) * | | | | | | | | | | | |
| (operator to be | 25*9765321 | 9 | | 7 | 6 | 5 | | 3 | 2 | 1 | |
| extended) * | | | | | | | | | | | |
| (operator to be | 26*8765321 | | 8 | 7 | 6 | 5 | | 3 | 2 | 1 | |
| extended) * | | | | | | | | | | | |
| (operator to be | 27*9874321 | 9 | 8 | 7 | | | 4 | 3 | 2 | 1 | |
| extended) * | | | | | | | | | | | |
| (operator to be | 28*9864321 | 9 | 8 | | 6 | | 4 | 3 | 2 | 1 | |
| extended) * | | | | | | | | | | | |
| (operator to be | 29*9764321 | 9 | | 7 | 6 | | 4 | 3 | 2 | 1 | |
| extended) * | | | | | | | | | | | |
| (operator to be | 30*8764321 | | 8 | 7 | 6 | | 4 | 3 | 2 | 1 | |
| extended) * | | | | | | | | | | | |
| (operator to be | 31*9854321 | 9 | 8 | | | 5 | 4 | 3 | 2 | 1 | |
| extended) * | | | | | | | | | | | |
| (operator to be | 32*9754321 | 9 | | 7 | | 5 | 4 | 3 | 2 | 1 | |
| extended) * | | | | | | | | | | | |
| (operator to be | 33*8754321 | | 8 | 7 | | 5 | 4 | 3 | 2 | 1 | |
| extended) * | | | | | | | | | | | |
| (operator to be | 34*9654321 | 9 | | | 6 | 5 | 4 | 3 | 2 | 1 | |
| extended) * | | | | | | | | | | | |
| (operator to be | 35*8654321 | | 8 | | 6 | 5 | 4 | 3 | 2 | 1 | |
| extended) * | | | | | | | | | | | |
| (operator to be | 36*7654321 | | | 7 | 6 | 5 | 4 | 3 | 2 | 1 | |
| extended) * | | | | | | | | | | | |
| (operator to be | 37*9876540 | 9 | 8 | 7 | 6 | 5 | 4 | | | | 0 |
| extended) * | | | | | | | | | | | |
| (operator to be | 38*9876530 | 9 | 8 | 7 | 6 | 5 | | 3 | | | 0 |
| extended) * | | | | | | | | | | | |
| (operator to be | 39*9876430 | 9 | 8 | 7 | 6 | | 4 | 3 | | | 0 |
| extended) * | | | | | | | | | | | |
| (operator to be | 40*9875430 | 9 | 8 | 7 | | 5 | 4 | 3 | | | 0 |
| extended) * | | | | | | | | | | | |
| (operator to be | 41*9865430 | 9 | 8 | | 6 | 5 | 4 | 3 | | | 0 |
| extended) * | | | | | | | | | | | |
| (operator to be | 42*9765430 | 9 | | 7 | 6 | 5 | 4 | 3 | | | 0 |
| extended) * | | | | | | | | | | | |
| (operator to be | 43*8765430 | | 8 | 7 | 6 | 5 | 4 | 3 | | | 0 |
| extended) * | | | | | | | | | | | |
| (operator to be | 44*9876520 | 9 | 8 | 7 | 6 | 5 | | | 2 | | 0 |
| extended) * | | | | | | | | | | | |
| (operator to be | 45*9876420 | 9 | 8 | 7 | 6 | | 4 | | 2 | | 0 |
| extended) * | | | | | | | | | | | |
| (operator to be | 46*9875420 | 9 | 8 | 7 | | 5 | 4 | | 2 | | 0 |
| extended) * | | | | | | | | | | | |
| (operator to be | 47*9865420 | | | 7 | | | | 3 | | 1 | |
| extended) * | | | | | | | | | | | |
| (operator to be | 48*9765420 | 9 | | 7 | 6 | 5 | 4 | | 2 | | 0 |
| extended) * | | | | | | | | | | | |
| (operator to be | 49*8765420 | | 8 | 7 | 6 | 5 | 4 | | 2 | | 0 |
| extended) * | | | | | | | | | | | |
| (operator to be | 50*9876320 | 9 | 8 | 7 | 6 | | | 3 | 2 | | 0 |
| extended) * | | | | | | | | | | | |
| (operator to be | 51*9875320 | 9 | 8 | 7 | | 5 | | 3 | 2 | | 0 |
| extended) * | | | | | | | | | | | |
| (operator to be | 52*9865320 | 9 | 8 | | 6 | 5 | | 3 | 2 | | 0 |
| extended) * | | | | | | | | | | | |
| (operator to be | 53*9765320 | 9 | | 7 | 6 | 5 | | 3 | 2 | | 0 |
| extended) * | | | | | | | | | | | |
| (operator to be | 54*8765320 | | 8 | 7 | 6 | 5 | | 3 | 2 | | 0 |
| extended) * | | | | | | | | | | | |
| (operator to be | 55*9874320 | 9 | 8 | 7 | | | 4 | 3 | 2 | | 0 |
| extended) * | | | | | | | | | | | |
| (operator to be | 56*9864320 | 9 | 8 | | 6 | | 4 | 3 | 2 | | 0 |
| extended) * | | | | | | | | | | | |
| (operator to be | 57*9764320 | 9 | | 7 | 6 | | 4 | 3 | 2 | | 0 |
| extended) * | | | | | | | | | | | |
| (operator to be | 58*8764320 | | 8 | 7 | 6 | | 4 | 3 | 2 | | 0 |
| extended) * | | | | | | | | | | | |
| (operator to be | 59*9854320 | 9 | 8 | | | 5 | 4 | 3 | 2 | | 0 |
| extended) * | | | | | | | | | | | |
| (operator to be | 60*9754320 | 9 | | 7 | | 5 | 4 | 3 | 2 | | 0 |
| extended) * | | | | | | | | | | | |
| (operator to be | 61*8754320 | | 8 | 7 | | 5 | 4 | 3 | 2 | | 0 |
| extended) * | | | | | | | | | | | |
| (operator to be | 62*9654320 | 9 | | | 6 | 5 | 4 | 3 | 2 | | 0 |
| extended) * | | | | | | | | | | | |
| (operator to be | 63*8654320 | | 8 | | 6 | 5 | 4 | 3 | 2 | | 0 |
| extended) * | | | | | | | | | | | |
| (operator to be | 64*7654320 | | | 7 | 6 | 5 | 4 | 3 | 2 | | 0 |
| extended) * | | | | | | | | | | | |
| (operator to be | 65*9876510 | 9 | 8 | 7 | 6 | 5 | | | | 1 | 0 |
| extended) * | | | | | | | | | | | |
| (operator to be | 66*9876410 | 9 | 8 | 7 | 6 | | 4 | | | 1 | 0 |
| extended) * | | | | | | | | | | | |
| (operator to be | 67*9875410 | 9 | 8 | 7 | | 5 | 4 | | | 1 | 0 |
| extended) * | | | | | | | | | | | |
| (operator to be | 68*9865410 | 9 | 8 | | 6 | 5 | 4 | | | 1 | 0 |
| extended) * | | | | | | | | | | | |
| (operator to be | 69*9765410 | 9 | | 7 | 6 | 5 | 4 | | | 1 | 0 |
| extended) * | | | | | | | | | | | |
| (operator to be | 70*8765410 | | 8 | 7 | 6 | 5 | 4 | | | 1 | 0 |
| extended) * | | | | | | | | | | | |
| (operator to be | 71*9876310 | 9 | 8 | 7 | 6 | | | 3 | | 1 | 0 |
| extended) * | | | | | | | | | | | |
| (operator to be | 72*9875310 | 9 | 8 | 7 | | 5 | | 3 | | 1 | 0 |
| extended) * | | | | | | | | | | | |
| (operator to be | 73*9865310 | 9 | 8 | | 6 | 5 | | 3 | | 1 | 0 |
| extended) * | | | | | | | | | | | |
| (operator to be | 74*9765310 | 9 | | 7 | 6 | 5 | | 3 | | 1 | 0 |
| extended) * | | | | | | | | | | | |
| (operator to be | 75*8765310 | | 8 | 7 | 6 | 5 | | 3 | | 1 | 0 |
| extended) * | | | | | | | | | | | |
| (operator to be | 76*9874310 | 9 | 8 | 7 | | | 4 | 3 | | 1 | 0 |
| extended) * | | | | | | | | | | | |
| (operator to be | 77*9864310 | 9 | 8 | | 6 | | 4 | 3 | | 1 | 0 |
| extended) * | | | | | | | | | | | |
| (operator to be | 78*9764310 | 9 | | 7 | 6 | | 4 | 3 | | 1 | 0 |
| extended) * | | | | | | | | | | | |
| (operator to be | 79*8764310 | | 8 | 7 | 6 | | 4 | 3 | | 1 | 0 |
| extended) * | | | | | | | | | | | |
| (operator to be | 80*9854310 | 9 | 8 | | | 5 | 4 | 3 | | 1 | 0 |
| extended) * | | | | | | | | | | | |
| (operator to be | 81*9754310 | 9 | | 7 | | 5 | 4 | 3 | | 1 | 0 |
| extended) * | | | | | | | | | | | |
| (operator to be | 82*8754310 | | 8 | 7 | | 5 | 4 | 3 | | 1 | 0 |
| extended) * | | | | | | | | | | | |
| (operator to be | 83*9654310 | 9 | | | 6 | 5 | 4 | 3 | | 1 | 0 |
| extended) * | | | | | | | | | | | |
| (operator to be | 84*8654310 | | 8 | | 6 | 5 | 4 | 3 | | 1 | 0 |
| extended) * | | | | | | | | | | | |
| (operator to be | 85*7654310 | | | 7 | 6 | 5 | 4 | 3 | | 1 | 0 |
| extended) * | | | | | | | | | | | |
| (operator to be | 86*9876210 | 9 | 8 | 7 | 6 | | | | 2 | 1 | 0 |
| extended) * | | | | | | | | | | | |
| (operator to be | 87*9875210 | 9 | 8 | 7 | | 5 | | | 2 | 1 | 0 |
| extended) * | | | | | | | | | | | |
| (operator to be | 88*9865210 | 9 | 8 | | 6 | 5 | | | 2 | 1 | 0 |
| extended) * | | | | | | | | | | | |
| (operator to be | 89*9765210 | 9 | | 7 | 6 | 5 | | | 2 | 1 | 0 |
| extended) * | | | | | | | | | | | |
| (operator to be | 90*8765210 | | 8 | 7 | 6 | 5 | | | 2 | 1 | 0 |
| extended) * | | | | | | | | | | | |
| (operator to be | 91*9874210 | 9 | 8 | 7 | | | 4 | | 2 | 1 | 0 |
| extended) * | | | | | | | | | | | |
| (operator to be | 92*9864210 | 9 | 8 | | 6 | | 4 | | 2 | 1 | 0 |
| extended) * | | | | | | | | | | | |
| (operator to be | 93*9764210 | 9 | | 7 | 6 | | 4 | | 2 | 1 | 0 |
| extended) * | | | | | | | | | | | |
| (operator to be | 94*8764210 | | 8 | 7 | 6 | | 4 | | 2 | 1 | 0 |
| extended) * | | | | | | | | | | | |
| (operator to be | 95*9854210 | 9 | 8 | | | 5 | 4 | | 2 | 1 | 0 |
| extended) * | | | | | | | | | | | |
| (operator to be | 96*9754210 | 9 | | 7 | 6 | 5 | 4 | | 2 | 1 | 0 |
| extended) * | | | | | | | | | | | |
| (operator to be | 97*8754210 | | 8 | 7 | | 5 | 4 | | 2 | 1 | 0 |
| extended) * | | | | | | | | | | | |
| (operator to be | 98*9654210 | 9 | | | 6 | 5 | 4 | | 2 | 1 | 0 |
| extended) * | | | | | | | | | | | |
| (operator to be | 99*8654210 | | 8 | | 6 | 5 | 4 | | 2 | 1 | 0 |
| extended) * | | | | | | | | | | | |
| (operator to be | 100*7654210 | | | 7 | 6 | 5 | 4 | | 2 | 1 | 0 |
| extended) * | | | | | | | | | | | |
| (operator to be | 101*9873210 | 9 | 8 | 7 | | | | 3 | 2 | 1 | 0 |
| extended) * | | | | | | | | | | | |
| (operator to be | 102*9863210 | 9 | 8 | | 6 | | | 3 | 2 | 1 | 0 |
| extended) * | | | | | | | | | | | |
| (operator to be | 103*9763210 | 9 | | 7 | 6 | | | 3 | 2 | 1 | 0 |
| extended) * | | | | | | | | | | | |
| (operator to be | 104*8763210 | | 8 | 7 | 6 | | | 3 | 2 | 1 | 0 |
| extended) * | | | | | | | | | | | |
| (operator to be | 105*9853210 | 9 | 8 | | | 5 | | 3 | 2 | 1 | 0 |
| extended) * | | | | | | | | | | | |
| (operator to be | 106*9753210 | 9 | | 7 | | 5 | | 3 | 2 | 1 | 0 |
| extended) * | | | | | | | | | | | |
| (operator to be | 107*8753210 | | 8 | 7 | | 5 | | 3 | 2 | 1 | 0 |
| extended) * | | | | | | | | | | | |
| (operator to be | 108*9653210 | 9 | | | 6 | 5 | | 3 | 2 | 1 | 0 |
| extended) * | | | | | | | | | | | |
| (operator to be | 109*8653210 | | 8 | | 6 | 5 | | 3 | 2 | 1 | 0 |
| extended) * | | | | | | | | | | | |
| (operator to be | 110*7653210 | | | 7 | 6 | 5 | | 3 | 2 | 1 | 0 |
| extended) * | | | | | | | | | | | |
| (operator to be | 111*9843210 | 9 | 8 | | | | 4 | 3 | 2 | 1 | 0 |
| extended) * | | | | | | | | | | | |
| (operator to be | 112*9743210 | 9 | | 7 | | | 4 | 3 | 2 | 1 | 0 |
| extended) * | | | | | | | | | | | |
| (operator to be | 113*8743210 | | 8 | 7 | | | 4 | 3 | 2 | 1 | 0 |
| extended) * | | | | | | | | | | | |
| (operator to be | 114*9643210 | 9 | | | 6 | | 4 | 3 | 2 | 1 | 0 |
| extended) * | | | | | | | | | | | |
| (operator to be | 115*8643210 | | 8 | | 6 | | 4 | 3 | 2 | 1 | 0 |
| extended) * | | | | | | | | | | | |
| (operator to be | 116*7643210 | | | 7 | 6 | | 4 | 3 | 2 | 1 | 0 |
| extended) * | | | | | | | | | | | |
| (operator to be | 117*9543210 | 9 | | | | 5 | 4 | 3 | 2 | 1 | 0 |
| extended) * | | | | | | | | | | | |
| (operator to be | 118*8543210 | | 8 | | | 5 | 4 | 3 | 2 | 1 | 0 |
| extended) * | | | | | | | | | | | |
| (operator to be | 119*7543210 | | | 7 | | 5 | 4 | 3 | 2 | 1 | 0 |
| extended) * | | | | | | | | | | | |
| (operator to be | 120*6543210 | | | | 6 | 5 | 4 | 3 | 2 | 1 | 0 |
| extended) * | | | | | | | | | | | |

h) Other Description.

1. Digital representation method. A normal number contains a series of numbers from 0 to 9. If there is a decimal number, the decimal point can be counted from front to back or from back to front.

A. Normal number writing (a decimal number): −1045.235.

B. A 10 decimal machine recognizes a writing 01045235(−3), in which “0” in the front indicates this is a negative number, and (−3) indicates that a decimal point is before a third to last bit of the number.

Coding scheme (combinatorial coding by using symbols occupying 4, 5 and 6 bits): using 2-bit symbols or 2-bit symbols and 1-bit numbers as the UNICODE code, in which there are 4-bit coding symbols (210 symbols), 5-bit coding symbols (252 symbols) and 6-bit coding (210 symbols), with a total of 252×210×2×2=211680 codes; and if the 1-bit number is added, there may be a total of 2116800+211680 codes.

### INDUSTRIAL APPLICABILITY

1. With technical schemes listed above, basic registers and instruction sets can be directly arranged and combined to design a complete computer CPU. Then, with aid of peripheral computer hardware devices, a complete computer can be formed.

2. The decimal computer cooperates with corresponding software code of hardware registers and instructions of the decimal computer so as to design the operating system of the decimal computer.

3. The decimal computer cooperated with the above hardware and software system may greatly improve efficiency of computing performance compared with the traditional binary computer, and unit cost may be greatly reduced. Moreover, it can complete similar applications to those of the binary computer in any industry or field.

### Language—Dependent Free Text

What is claimed is:

1. Basic technical principle and implementation of a decimal computer, wherein unit data is expressed as decimal data and a unit number has ten states, the decimal data is used as computation basis of hardware computation registers of the computer, and computation of the decimal computers is made using decimal data and registers.

2. The basic technical principle and implementation of the decimal computer according to claim 1, wherein the unit data has ten BITs and the unit number has ten expressed states.

3. The basic technical principle and implementation of the decimal computer according to claim 1, wherein the unit data has ten BITs, but only one BIT is needed to express the number; since the unit data has ten BITs and except for a single BIT for expressing the number, there are a total of more than 1,000 states by combining other 2 to 9 BITs for use, combinations of 2 to 9 BITs serve to express characters, operators and operands of the decimal computer, and two characters are combined to completely express Uicode code.

4. The basic technical principle and implementation of the decimal computer according to claim 3, wherein for a ten-bit data, except a single BIT for the number, combinations of other Bits are for the characters, operators, operands and the Uicode code; and single-bit operators and operands are combined to be complete machine code, which is directly expressed by an operation control symbol in a high-level computer programming language, that is, programming of the machine code is directly completed by using the high-level language.

5. The basic technical principle and implementation of the decimal computer according to claim 1, wherein a basic hardware computation register is a decimal register expressed in a ten-bit state, and on this basis, a plurality of single-bit decimal registers are combined and arranged together to form an addition register group, a subtraction register group, a multiplication register group and a division register group, and also are combined into computation register groups required by various hardware computation required in other various computer core CPUs.

6. The basic technical principle and implementation of the decimal computer according to claim 1, wherein a single-bit register involves a decimal number, and multi-bit decimal registers constitute a multi-bit hardware register group, and the multi-bit decimal register group arranged is configured to perform computation of multi-bit data in a multi-bit and parallel manner; or multiple sets of data are input into a register group at the same time to complete parallel computation of the multiple sets of data input at one time.

7. The basic technical principle and implementation of the decimal computer according to claim 1, wherein commonly used data is decimal, and it is not necessary for the decimal computer to convert the decimal data into binary data for computation; when the decimal data is converted into the binary data for computation which is then converted back to decimal data, there is loss of data accuracy, but the decimal computer is configured to compute in a decimal manner directly.

8. The basic technical principle and implementation of the decimal computer according to claim 1, wherein the decimal computer performs multi-bit synchronous computation, and according to computation of different data, some computations are completed in one step, while others are completed in multiple steps; thus, a corresponding crossbar needs to be developed for the decimal computer and results are output immediately after data computation is completed, and the crossbar, which regulates a working sequence of multiple register groups in the decimal computer, is a special auxiliary computation controller.

9. The basic technical principle and implementation of the decimal computer according to claim 1, wherein the decimal data has ten BITs, so a memory for the decimal data adopts a new hardware memory with a unit of ten BITs.

10. The basic technical principle and implementation of the decimal computer according to claim 1, wherein decimal computation is directly performed, with simple data computation of the computer and simple register arrangement and combination, and multi-bit computation registers are easily combined, a preliminary design of this system is a 100-bit decimal computer designed by 100-bit decimal data; and a number of registers arranged is increased so as to combine a decimal computer of more bits.

11. The basic technical principle and implementation of the decimal computer according to claim 1, comprising a decimal operation register group, a decimal number, various characters represented by 10 BITs, an ten-bit operation controller and a ten-bit operand, a decimal data storage, a special crossbar controller for the decimal computation, based on which a complete CPU of the decimal computer for decimal computation and a corresponding hardware system for decimal computation principle are formed.

12. The basic technical principle and implementation of the decimal computer according to claim 11, wherein with decimal computer hardware used for direct operation of the decimal data, a decimal computer operating system adapted to computation of the unit data in a ten-bit state is developed in the decimal computer according to characteristics that the data is expressed in ten states and the unit data has ten BITs.

13. The basic technical principle and implementation of the decimal computer according to claim 10, wherein the computer has enough address bits and data bit widths, with addresses of up to more than 40 bits and a data bit width of more than 100 bits, and direct hardware addressing is made for several thousand terabytes of data, most computation and software codes, directly executable machine codes, reside in a memory to speed up the computation, and a commonly used part of data in a database resides in the memory to speed up the computation.

14. The basic technical principle and implementation of the decimal computer according to claim 13, wherein because there is enough data addressing space for quick addressing and quick computation, a large number of program codes and a part of the database is accessed quickly and completed by residing in the memory as a part of computation application data.

15. The basic technical principle and implementation of the decimal computer according to claim 3, wherein unit decimal data has ten states, and multiple states are expressed via an input and output IO port of the decimal computer, so that control information of an output state register and input and output states required by the IO are be input or output in one step.
